(19) United States
(12) Patent Application Publication
(10) Pub. No.: US 2024/0347720 A1
(43) Pub. Date: Oct. 17, 2024

(54) SECONDARY BATTERY

(71) Applicant: TOYOTA JIDOSHA KABUSHIKI KAISHA, Toyota-shi (JP)

(72) Inventors: Shohei KAWASHIMA, Susono-shi (JP); Jun Yoshida, Susono-shi (JP); So Yubuchi, Sunto-gun (JP)

(73) Assignee: TOYOTA JIDOSHA KABUSHIKI KAISHA, Toyota-shi (JP)

(21) Appl. No.: 18/418,487

(22) Filed: Jan. 22, 2024

(30) Foreign Application Priority Data
Apr. 17, 2023 (JP) 2023-067241

(51) Int. Cl. H01M 4/525; H01M 4/505; H01M 10/0562

(52) U.S. Cl. CPC H01M 4/525; H01M 4/505; H01M 10/0562; H01M 2300/008

(57) ABSTRACT

The disclosed secondary battery includes a cathode active material layer, a solid electrolyte layer, and an anode active material layer, wherein the cathode active material layer includes a cathode active material having a O2 type construction, and the cathode active material layer includes an inorganic solid electrolyte having a Young's modulus of 30 GPa or less.

### CROSS-REFERENCE TO RELATED APPLICATION

This application claims priority to Japanese Patent Application No. 2023-067241 filed on Apr. 17, 2023, incorporated herein by reference in its entirety.

### BACKGROUND

### 1. Technical Field

The present application discloses a secondary battery.

### 2. Description of Related Art

Japanese Unexamined Patent Application Publication No. 2022-085829 (JP 2022-085829 A) discloses use of a solid electrolyte together with a cathode active material having an O2 type structure in a cathode active material layer of a secondary battery.

### SUMMARY

In the related-art secondary battery, resistance is likely to increase when charge and discharge are repeated.

The present application discloses the following aspects as means for solving the above problem.

### First Aspect

A secondary battery includes a cathode active material layer, a solid electrolyte layer, and an anode active material layer. The cathode active material layer includes a cathode active material having an O2 type structure. The cathode active material layer includes an inorganic solid electrolyte having a Young's modulus of 30 GPa or less.

### Second Aspect

In the secondary battery according to the first aspect, the cathode active material may at least include, as constituent elements, at least one kind of transition metal element among Mn, Ni, and Co, Li, and O.

### Third Aspect

In the secondary battery according to the first or second aspect, the cathode active material may have a chemical composition represented by LiₐNa_{b}Mnₓ₋ₚNi_{y-q}Co_{z-r}M_{p+q+r}O₂, where 0<a≤1.00, 0≤b≤0.20, x+y+z=1, and 0≤p+q+r≤0.15 hold, and an element M is at least one kind selected from among B, Mg, Al, K, Ca, Ti, V, Cr, Fe, Cu, Zn, Ga, Ge, Sr, Y, Zr, Nb, Mo, and W.

### Fourth Aspect

In the secondary battery according to any one of the first to third aspects, the inorganic solid electrolyte may at least include Li, P, S, and a halogen element as constituent elements.

### Fifth Aspect

In the secondary battery according to any one of the first to fourth aspects, the Young's modulus of the inorganic solid electrolyte may be 10 GPa or more and 30 GPa or less.

The secondary battery of the present disclosure has a small increase in resistance when charge and discharge are repeated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an exemplary configuration of a secondary battery; and

FIG. 2 shows the relationship between the Young's modulus of the solid electrolyte contained in the cathode active material layer and the resistivity increase rate of the secondary battery.

### DETAILED DESCRIPTION OF EMBODIMENTS

Hereinafter, an embodiment of a secondary battery of the present disclosure will be described, but the secondary battery of the present disclosure is not limited to the embodiment shown below.

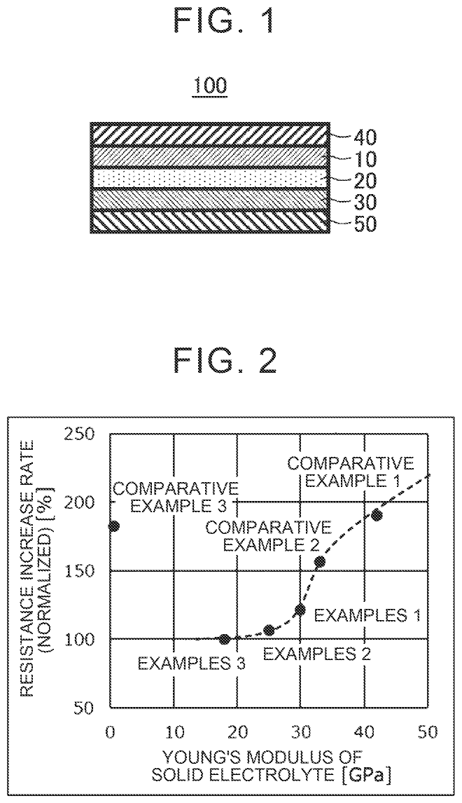

As illustrated in FIG. 1, a secondary battery 100 according to an embodiment includes a cathode active material layer 10, a solid electrolyte layer 20, and an anode active material layer 30. The cathode active material layer 10 includes a cathode active material having a O2 type configuration. In addition, the cathode active material layers 10 may include an inorganic-solid electrolyte having a Young's modulus of 30 GPa or less.

### 1. Cathode Active Material Layer

The cathode active material layers 10 include a cathode active material having a O2 type and an inorganic-solid electrolyte having a Young's modulus of 30 GPa or less. The cathode active material layer 10 may optionally contain a conductive auxiliary agent or a binder. The cathode active material layer 10 may optionally include other cathode active materials or other electrolytes. The cathode active material layer 10 may optionally contain various additives. The content of each component in the cathode active material layer 10 may be appropriately determined according to the desired battery performance. For example, the entire cathode active material layer 10 (solid whole) as 100% by mass, the content of the cathode active material having a O2 type structure, 40% by mass or more, may be 50% by mass or more or 60% by mass or more, 99% by mass or less, 95% by mass or less, 90% by mass or less or 85% by mass or less it may be. The content of the inorganic solid electrolyte having a Young's modulus of 30 GPa or less may be 1% by mass or more, 5% by mass or more, or 10% by mass or more, and may be 60% by mass or less, 50% by mass or less, or 40% by mass or less, with the entire cathode active material layer 10 (the entire solid content) being 100% by mass. The shape of the cathode active material layer 10 is not particularly limited, and may be, for example, a sheet shape having a substantially flat surface. The thickness of the cathode active material layers 10 is not particularly limited, and may be, for example, 0.1 μm or more or 1 μm or more, and may be 2 mm or less or 1 mm or less.

1.1. Cathode Active Material having O2 Type Structure

The cathode active material layer 10 includes a cathode active material having a O2 type structure. The cathode active material has at least a O2 type structure (belonging to the space group P63mc) as a crystalline structure. The cathode active material may have a O2 type structure and a crystalline structure other than O2 type structure. Examples of the crystal structure other than O2 type structure include, for example, a T #2 type structure (belonging to the space group Cmca) formed when Li is removed from the O2 type structure, a 06 type structure (06 type structure belongs to the space group R-3m, and has a c-axis length of not less than 2.5 nm and not more than 3.5 nm, typically not less than 2.9 nm and not more than 3.0 nm, and differs from 03 type structure belonging to the same space group R-3m). The cathode active material may have a O2 type structure as a main phase, or may have a crystalline structure other than a O2 type structure as a main phase. The crystal structure as the main phase of the cathode active material may be changed depending on the charge-discharge state.

The cathode active material having a O2 type may include at least one transition-metal element selected from Mn, Ni and Co, a Li, and O as constituent elements. In particular, when the cathode active material having a O2 type structure includes at least one of Mn, a Ni, and a Co, a Li, and O as constituent elements, higher performance is easily ensured when the cathode active material includes at least Li, a Mn, a Ni, a Co, and O as constituent elements. However, Li of the cathode active material may be almost completely released by the charge, and the molarity of Li may approach 0 to the limit. In addition, the cathode active material having a O2 type may contain Na as a constituent element due to a manufacturing process thereof. In addition, the cathode active material may include an element M described later. The cathode active material may include other impurity elements. In one embodiment, the cathode active material having a O2 type structure may have a chemical composition represented by LiₐNa_{b}Mnₓ₋ₚNi_{y-q}Co_{z-r}M_{p+q+r}O₂ (where a relation of 0<a≤1.00, 0≤b≤0.20, x+y+z=1, and 0≤p+q+r≤0.15 is held, and an element M is at least one kind selected from among B, Mg, Al, K, Ca, Ti, V, Cr, Fe, Cu, Zn, Ga, Ge, Sr, Y, Zr, Nb, Mo, and W). In the chemical composition, a may be more than 0, 0.10 or more, 0.20 or more, 0.30 or more, 0.40 or more, 0.50 or more, or 0.60 or more, and may be 1.00 or less, 0.90 or less, 0.80 or less, or 0.70 or less. In addition, b may be 0 or more or 0 or more, and may be 0.15 or less, 0.10 or less, 0.05 or less, 0.04 or less, 0.03 or less, 0.02 or less, or 0.01 or less. Further, x may be 0 or more, 0.10 or more, 0.20 or more, 0.30 or more, 0.40 or more, or 0.50 or more, and may be 1.00 or less, 0.90 or less, 0.80 or less, 0.70 or less, 0.60 or less, or 0.50 or less. Further, y may be 0 or more, 0.10 or more, or 0.20 or more, and may be 1.00 or less, 0.90 or less, 0.80 or less, 0.70 or less, 0.60 or less, 0.50 or less, 0.40 or less, 0.30 or less, or 0.20 or less. Further, z may be 0 or more, 0.10 or more, 0.20 or more, or 0.30 or more, and may be 1.00 or less, 0.90 or less, 0.80 or less, 0.70 or less, 0.60 or less, 0.50 or less, 0.40 or less, or 0.30 or less. The contribution of the element M to charge and discharge is small. In this regard, in the above chemical composition, when p+q+r is 0.15 or less, a high charge-discharge capacity is easily secured. p+q+r may be 0.12 or less, 0.10 or less, 0.08 or less, 0.06 or less, 0.05 or less, or 0.04 or less. On the other hand, when the element M is contained, O2 type structure is easily stabilized. In this regard, in the above chemical composition, p+q+r is 0 or more, and may be more than 0, 0.01 or more, 0.02 or more, or 0.03 or more. The composition of O is approximately 2, but not necessarily equal to 2.0, and is undefined. In addition, when the valence of the element M is +n in the chemical composition of the cathode active material having the O-type structure, the relationship of 3.0≤4 (x−p)+2 (y−q)+3 (z−r)+n (p+q+r)≤3.5 may be satisfied. This means that the total valence of the metal in the cathode active material is in a range close to 3.33 valence (charge neutrality when a is 0.67). The cathode active material having a O2 type structure is synthesized through a Na containing transition-metal oxide having a P2 type structure. A case where Na content at this time is 0.5 or more and 1.0 or less is charge-neutral corresponds to a case where the above relation is satisfied.

The cathode active material having a O2 type may be, for example, particulate. The cathode active material particles may be solid particles, hollow particles, or those having voids. The cathode active material particles may be primary particles or secondary particles each of which includes multiple primary particles that are aggregated. The average particle diameter (D50) of the cathode active material particles may be, for example, 1 nm or more, 5 nm or more or 10 nm or more, 500 μm or less, 100 μm or less, 50 μm or less or 30 μm or less. The average particle diameter D50 referred to in the present application is a particle diameter (median diameter) at an integrated value of 50% in a volume-based particle size distribution obtained by a laser diffraction and scattering method.

A protective layer containing an ion-conductive oxide may be formed on the surface of the cathode active material. As a result, a reaction or the like between the cathode active material and another battery material (for example, an inorganic solid electrolyte or the like described later) is easily suppressed. As an ion-conducting oxide, for example, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄, etc. The ion conductive oxide may be one in which a part of the elements is replaced by a doping element such as P or B. The coverage ratio (area ratio) of the protective layer to the surface of the cathode active material may be, for example, 70% or more, 80% or more, or 90% or more. The thickness of the protective layer may be, for example, 0.1 nm or more or 1 nm or more, or may be 100 nm or less or 20 nm or less.

### 1.2. Inorganic Solid-State Electrolytes Having Young's Modulus Less Than or Equal to 30 GPa

The cathode active material layer 10 includes a cathode active material having a O2 type and an inorganic-solid electrolyte having a Young's modulus of 30 GPa or less. The Young's modulus of the inorganic-solid electrolyte may be greater than or equal to 10 GPa and less than or equal to 30 GPa, or greater than or equal to 15 GPa and less than or equal to 25 GPa. In the present application, “Young's modulus” refers to Young's modulus at 25° C. The Young's modulus of the inorganic solid electrolyte can be measured by a nanoindenter. According to the findings of the present inventors, a cathode active material having a O2 type has a large volume change due to charging and discharging. Therefore, in a conventional secondary battery in which a solid electrolyte is used together with a cathode active material having a O2 type structure, when charging and discharging are repeated, contacts between the cathode active material and the solid electrolyte cannot be maintained, or voids are formed in the cathode active material layer due to volume change of the cathode active material, so that the resistivity of the secondary battery tends to be increased. On the other hand, as in the present embodiment, when the cathode active material layer 10 includes an inorganic solid electrolyte having a Young's modulus of 30 GPa or less, even when the volume of the cathode active material changes with charging and discharging, for example, the inorganic solid electrolyte is deformed so as to follow the volume change, so that the cathode active material and the inorganic solid electrolyte are maintained in contact with each other, and the inorganic solid electrolyte is replenished in the voids caused by the volume change of the cathode active material, thereby reducing the resistivity of the secondary battery.

The Young's modulus of the inorganic solid electrolyte varies depending on constituent elements. The inorganic solid electrolyte may be, for example, a sulfide solid electrolyte containing S as a constituent element, a halide solid electrolyte containing a halogen element as a constituent element, or a complex hydride solid electrolyte containing a complex ion. Among these, a sulfide solid electrolyte, a halogenated solid electrolyte, and a complex hydride solid electrolyte, those having a Young's modulus of 30 GPa or less may be employed. In particular, when the inorganic-solid electrolyte contains at least Li, P, S, and a halogen element as constituent elements, the inorganic-solid electrolyte tends to have a Young's modulus less than or equal to 30 GPa and to have excellent ionic conductivity.

The sulfide solid electrolyte may be a glass-based sulfide solid electrolyte (sulfide glass), a glass-ceramic-based sulfide solid electrolyte, or a crystal-based sulfide solid electrolyte. The sulfide glass is amorphous. The sulfide glass preferably has a glass transition temperature (Tg). When the sulfide solid electrolyte has a crystalline phase, examples of the crystalline phase include a Thio-LISICON crystalline phase, a LGPS crystalline phase, and an argyrodite crystalline phase. The sulfide solid electrolyte preferably contains, for example, a Li element, an X element (X is at least one of P, As, Sb, Si, Ge, Sn, B, and Al, Ga, In), and an S element. The sulfide solid electrolyte may further contain at least one of an O element and a halogen element. The sulfide solid electrolyte preferably contains an S element as a main component of an anion element. As described above, the sulfide solid electrolyte may include at least Li, P, S, and a halogen element as constituent elements.

The halide solid electrolyte is, for example, represented by the formula (A):

Li_{α}M_{β}X_{γ} (A)

It may have the chemical composition shown. Here, α, β, and γ are each independently greater than 0. M is at least one selected from the group consisting of a metal element and a metalloid element other than Li. X is at least one selected from the group consisting of Cl, Br and I. The “metalloid element” may be at least one selected from the group consisting of B, Si, Ge, As, Sb, and Te. Further, the “metal element” may include (i) all elements included in Groups 1 to 12 of the periodic table (except for hydrogen) and (ii) all elements included in Groups 13 to 16 of the periodic table (except for B, Si, Ge, As, Sb, Te, C, N, P, O, S and Sc).

The complex hydride solid electrolyte may be composed of Li ions and complex ions comprising H. The complex ion containing H may have, for example, an element A containing at least one of a non-metal element, a metalloid element, and a metal element, and H bonded to the element A. Further, the complex ion containing H may be bonded to each other through a covalent bond between the element A as a central element and the H surrounding the element A. The complex ion containing H may be represented by (AₘHₙ)^{α-}. In this case, m is an arbitrary positive number, and n and α may take an arbitrary positive number depending on the equivalent number of m and the element A. The element A may be any non-metal element or metal element capable of forming a complex ion. For example, the element A may include at least one of B, C, and N as a non-metallic element, and may include B. Further, for example, the element A may include at least one of Al, Ni and Fe as the metallic element. Especially when the complex ion contains B or C and B, it is easy to ensure soft and higher ion conductivity. Specific examples of the complex ion containing H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations thereof. In particular, when using (CB₉H₁₀)⁻, (CB₁₁H₁₂)⁻, or a combination thereof, higher ionic conductivity is likely to be ensured. That is, the complex hydride solid electrolyte may include Li, C, B, and H.

### 1.3. Other Ingredients

Examples of the conductive auxiliary agent that can be included in the cathode active material layer 10 include carbon materials such as vapor-phase carbon fibers (VGCF), acetylene black (AB), Ketjen black (KB), carbon nanotubes (CNT), and carbon nanofibers (CNF); and metallic materials such as nickel, titanium, aluminum, and stainless steel. The conductive aid may be, for example, in the form of particles or fibers, and its size is not particularly limited. Only one type of conductive aid may be used alone, or two or more types may be used in combination.

Examples of the binder that can be included in the cathode active material layer 10 include a butadiene rubber (BR) binder, a butylene rubber (IIR) binder, an acrylate butadiene rubber (ABR) binder, a styrene butadiene rubber (SBR) binder, a polyvinylidene fluoride (PVdF) binder, a polytetrafluoroethylene (PTFE) binder, and a polyimide (PI) binder. Only one type of the binder may be used alone, or two or more types may be used in combination.

The cathode active material layer 10 may contain various additives in addition to the above-described components. Examples include dispersants and lubricants. The cathode active material layer 10 may include other cathode active materials or other electrolytes.

### 2. Solid Electrolyte Layer

The solid electrolyte layer 20 is disposed between the cathode active material layer 10 and the anode active material layer 30. The solid electrolyte layer 20 includes at least a solid electrolyte. The solid electrolyte contained in the solid electrolyte layer 20 may be an inorganic solid electrolyte or an organic polymer electrolyte. In particular, the performance of the inorganic solid electrolyte, among them, the sulfide solid electrolyte is high. The solid electrolyte layer 20 may contain a liquid component together with the solid electrolyte, and may optionally contain a binder, various additives, and the like. The content of the solid electrolyte or the like in the solid electrolyte layer 20 is not particularly limited. The thickness of the solid electrolyte layers 20 is not particularly limited, and may be, for example, 0.1 μm or more and 2 mm or less, the lower limit may be 1 μm or more, and the upper limit may be 1 mm or less. The solid electrolyte layer 20 may be formed of one layer or may be formed of a plurality of layers. For example, the solid electrolyte layer 20 may include a first layer disposed on the cathode active material layer 10 side and a second layer disposed on the anode active material layer 30 side. The first layer may include a first electrolyte and the second layer may include a second electrolyte. The first electrolyte and the second electrolyte may be of different types. Each of the first electrolyte and the second electrolyte may be at least one selected from the various inorganic solid electrolytes described above. For example, the first layer may include a halide solid electrolyte, and the second layer may include at least one of a halide solid electrolyte and a sulfide solid electrolyte.

### 3. Anode Active Material Layer

The anode active material layer 30 includes at least an anode active material, and may optionally further include an electrolyte, a conductive auxiliary agent, a binder, various additives, and the like. The content of each of the anode active material, the electrolyte, the conductive auxiliary agent, the binder, and the like in the anode active material layer 30 may be appropriately determined in accordance with the desired battery performance. The shape of the anode active material layer 30 is not particularly limited, and may be, for example, a sheet-like anode active material layer having a substantially flat surface. The thickness of the anode active material layers 30 is not particularly limited, and may be, for example, 0.1 μm or more or 1 μm or more, and may be 2 mm or less or 1 mm or less. As the anode active material, for example, a silicon-based active material such as Si, a Si alloy, or silicon oxide; a carbon-based active material such as graphite or hard carbon; various oxide-based active materials such as lithium titanate; and a metallic lithium or a lithium alloy can be employed. Only one type of the anode active material may be used alone, or two or more types may be used in combination. The electrolyte, the conductive auxiliary agent, and the binder that may be included in the anode active material layer 30 may be appropriately selected from those exemplified as those that may be included in the cathode active material layer 10 described above, for example.

### 4. Other Configurations

As shown in FIG. 1, the secondary battery 100 may include a positive electrode current collector 40 electrically connected to the cathode active material layer 10 and a negative electrode current collector 50 electrically connected to the anode active material layer 30. As the configuration of the current collector, a known configuration may be adopted. In addition to the above-described configuration, the secondary battery 100 may have a general configuration as a secondary battery. Such a configuration is, for example, a tab, a terminal, or the like. In addition, the secondary battery 100 may be configured such that each of the above-described configurations is housed in an exterior body. As the exterior body, any known exterior body of the battery can be adopted. Further, a plurality of batteries 100 may be arbitrarily electrically connected and optionally stacked to form an assembled battery. Examples of the shape of the secondary battery 100 include a coin type, a laminated type, a cylindrical type, and a square type. The secondary battery 100 can be manufactured through, for example, a process of forming each of the above-described layers by a dry process or a wet process.

Hereinafter, the technology of the present disclosure will be described in more detail with reference to examples. However, the technology of the present disclosure is not limited to the following examples.

### 1. Production of Cathode Active Material

### 1.1. Preparation of Precursor Particles

MnSO₄·5H₂O, NiSO₄·6H₂O and CoSO₄·7H₂O were weighed to achieve the desired compositional ratio and dissolved in distilled water so as to have a 1.2 mol/L level to obtain the first liquid. Na₂CO₃ was dissolved in distilled water so as to have a 1.2 mol/L level in another vessel to obtain a second liquid. Subsequently, a 500 mL of the first liquid and the second liquid were dropped at a rate of about 4 mL/min into a reactor in which 1000 mL pure water was previously contained. After completion of the dropwise addition, the solution was 1 h stirred at room temperature 150 rpm a stirring rate. The precipitate was washed with pure water and subjected to a solid-liquid separation treatment by a centrifugal separator. The resulting precipitate was dried at 120° C. overnight and the particulates were removed by air flow classification after mortar grinding. This resulted in precursors comprising Mn, Ni and Co.

### 1.2. Preparation of Coated Particles

Na₂CO₃ was dissolved in distilled water to produce a Na₂CO₃ aqueous solution. Na₂CO₃ aqueous solution was mixed with the above precursors to obtain a slurry. Na₂CO₃ and the above-described precursor particles were mixed after being dried to form a Na_{0.7}Mn_{0.5}Ni_{0.2}Co_{0.3}O₂. The resulting slurry was dried by spray drying. Specifically, using a spray dryer DL410, the surface of the precursor particles was coated with a Na₂CO₃ under the conditions of a slurry feed rate 30 mL/min, an inlet temperature of 200° C., a circulating air volume 0.8 m³/min, and a spray air pressure 0.3 MPa to obtain coated particles.

1.3. Preparation of Na Oxides with P2 Type Structures

Coated particles were fired in an electric furnace using an alumina crucible under an atmospheric atmosphere. Specifically, an alumina crucible with coated particles was installed in an electric furnace. Further, as shown in Table 1 below, “first temperature raising step”, “preliminary firing step”, “second temperature raising step”, “main firing step”, “in-furnace cooling step”, and “out-of-furnace cooling step” were performed. The “in-furnace cooling step” means a cooling step in an electric furnace. The “out-of-furnace cooling step” means a step of performing cooling outside the electric furnace. Then, Na containing oxide having a P2 type (Na_{0.7}Mn_{0.5}Ni_{0.2}Co_{0.3}O₂) was obtained by grinding in a mortar at a dew point of −30° C. or lower.

TABLE 1

| | Starting | End | | Heating Rate or |
|---|---|---|---|---|
| | Temperature | Temperature | Time | Cooling Rate |
| Process | [° C.] | [° C.] | [min] | [° C./min] |
| First Temperature | 25 | 600 | 115 | 5 |
| Raising Step | | | | |
| Pre-Firing | 600 | 600 | 360 | 0 |
| Process | | | | |
| Second | 600 | 900 | 100 | 3 |
| Temperature | | | | |
| Raising Step | | | | |
| Main Firing | 900 | 900 | 60 | 0 |
| Process | | | | |
| In-Furnace | 900 | 250 | 130 | 5 |
| Cooling Process | | | | |
| Off-Furnace | 250 | 25 | 10 | 22.5 |
| Cooling Process | | | | |

### 1.4. Ion Exchange

LiNO₃ and LiCl were weighed to a molar ratio of 50:50 and mixed with Na containing oxide at a molar ratio of 10 times the lowest Li required for ion-exchange to obtain mixtures. Subsequently, the mixtures were calcined 1 h at 280° C. using an alumina crucible in an atmosphere. The salt remaining after the calcination was washed with pure water and subjected to a solid-liquid separation treatment by vacuum filtration. The obtained precipitate was dried at 120° C. overnight to obtain a Li oxide (Li_{0.6}Mn_{0.5}Ni_{0.2}Co_{0.3}O₂) as a cathode active material. X-ray diffractometry was performed on Li containing oxide, and Li containing oxide had a O2 type structure as a crystalline structure.

### 2. Production of Positive Electrode

The cathode active material, the solid-state electrolyte shown in Table 2 below, the vapor-grown carbon fiber (VGCF), PVdF binder, and the butyl butyrate were stirred and mixed by an ultrasonic dispersing device to obtain a positive electrode slurry. Here, the weight ratio of the cathode active material, the solid electrolyte, VGCF, and PVdF binder was as follows: cathode active material:solid electrolyte:VGCF:PVdF binder=82.1:14.9:2.5:0.6. The obtained positive electrode slurry was coated on an Al foil as a positive electrode current collector by a blade method, and dried on a hot plate at 120° C. for 30 minutes to obtain a positive electrode having a cathode active material layer and a positive electrode current collector.

### 3. Preparation of Negative Electrode

A negative electrode slurry was obtained by stirring and mixing lithium titanate as an anode active material, a sulfide solid electrolyte (Li₂S—P₂S₅—LiI—LiBr), VGCF, a PVdF based binder, and butyl butyrate by an ultrasonic dispersing device. Here, the weight ratio of the anode active material, the sulfide solid electrolyte, VGCF, and PVdF binder was 72.1:22.7:1.7:3.5 in the anode active material:sulfide solid electrolyte:VGCF:PVdF binder. The obtained positive electrode slurry was coated on a Ni foil as a negative electrode current collector by a blade method, and dried on a hot plate at 120° C. for 30 minutes to obtain a negative electrode having an anode active material layer and a negative electrode current collector.

### 4. Preparation of Solid Electrolyte Layer

A solid electrolyte slurry was obtained by stirring and mixing a sulfide solid electrolyte (Li₂S—P₂S₅—LiI—LiBr), a PVdF based binder, and butyl butyrate by an ultrasonic dispersing device. Here, the mass-ratio of the sulfide solid electrolyte and PVdF based binder was sulfide solid electrolyte:PVdF based binder=99.4:0.4. The obtained solid electrolyte slurry was coated on a Ni foil as a substrate by a blade method, and dried on a hot plate at 120° C. for 30 minutes to obtain a transfer laminate having a solid electrolyte layer on the surface of the substrate.

### 5. Preparation of Evaluation Battery

The cathode active material layer of the positive electrode and the solid electrolyte layer of the transfer laminate were superposed, pressed at a 50 kN/cm press pressure and a temperature of 160° C. in a roll press machine, and then Al foil as a base material was peeled off and punched out to a size of 1 cm², whereby a positive electrode laminate having a configuration of a positive electrode current collector/cathode active material layer/solid electrolyte layer was obtained.

After the anode active material layer of the negative electrode and the solid electrolyte layer of the transfer laminate were superposed on each other and pressed by a roll press at a 50 kN/cm press pressure and a temperature of 160° C., Al foil as a base material was peeled off, thereby obtaining a first negative electrode laminate having a structure of a solid electrolyte layer/anode active material layer/negative electrode current collector.

The solid electrolyte layer of the transfer laminate was further superimposed on the solid electrolyte layer of the first negative electrode laminate, and Al foil as a base material was peeled off and punched to a size of 1.08 cm² after a temporary press was performed at a 100 MPa press pressure and a temperature of 25° C. in a flat uniaxial press machine, whereby a second negative electrode laminate having a structure of a solid electrolyte layer/solid electrolyte layer/anode active material layer/negative electrode current collector was obtained.

The above positive polar laminated body and the second negative polar laminated body were laminated so that the solid electrolyte laminated bodies overlapped, and pressed with a planar one-axis press machine at a 200 MPa press pressure and a temperature of 120° C., resulting in a battery laminated body with a configuration of positive polar collector/cathode active material layer/solid electrolyte layer/solid electrolyte layer/anode active material layer/negative polar collector.

A laminate material having a positive electrode tab and a laminate material having a negative electrode tab sandwiched between the above-described battery laminates and thermally sealed under vacuum to obtain an all-solid-state battery for evaluation.

### 6. Evaluation of Batteries

The resulting all-solid-state batteries were sandwiched between two restraining plates, and the two restraining plates were fastened with fasteners at 5 MPa restraining pressures to fix the spacing between the two restraining plates. Three sets of constant-current charging/discharging of 1/10 C and constant-voltage charging/discharging up to the termination current 1/100 C were performed on the all-solid-state batteries restrained in this manner in the voltage range from 0.45 V to 3.25 V. Thereafter, constant-current charging of 1/10 C up to 3.25 V and constant-voltage charging up to the termination current 1/100 C were performed. Further, SOC was adjusted by performing constant current discharge in 1/10 C up to 2.5 V and constant voltage discharge up to the termination current 1/100 C. A constant current discharge of 3 C, 10 s was performed on the all-solid-state battery in which SOC was adjusted, and the initial resistance value was calculated by dividing the difference between the voltage before the discharge and the voltage at the end of the discharge by the current value.

After measuring the initial resistance, 300 cycles of constant current charging and discharging of 2 C were performed in the voltage-range from 0.45 V to 3.0 V to obtain a durable all-solid-state battery. Thereafter, constant current charging of 1/10 C up to 3.25 V and constant voltage charging up to the termination current 1/100 C were performed, and then constant current discharging of 1/10 C up to 2.5 V and constant voltage discharging up to the termination current 1/100 C were performed, whereby SOC after the endurance was adjusted. The all-solid-state battery in which SOC after the durability was adjusted was subjected to constant current discharge of 3 C, 10 s, and the resistance value after the durability was calculated by dividing the difference between the voltage before the discharge and the voltage at the end of the discharge by the current value.

Based on the initial resistance value and the resistance value after durability measured as described above, the resistance increase rate was calculated from the following equation.

Resistance increase rate (%)=resistance value after durability (Ω)/initial resistance value (Ω)×100

### 7. Evaluation Results

Table 2 below shows the chemical composition of the solid electrolyte used in the cathode active material layer, the Young's modulus at 25° C., and the resistance increase rate of the evaluation battery. In Table 2, the resistivity increase rate of each of the batteries according to Examples 1 and 2 and Comparative Examples 1 to 3 is shown relative to the resistivity increase rate of the battery according to Example 3 as a reference (100%).

TABLE 2

| | | Solid Electrolyte | Resistance |
|---|---|---|---|
| | Solid Electrolyte | Young's | Increase Rate |
| | Chemical | Modulus | (Normalized) |
| | Composition | [GPa] | [%] |
| Example 1 | Li5.5PS4.5Cl1.5 | 30 | 121 |
| Example 2 | Li5.4PS4.4Cl1.6 | 25 | 107 |
| Example 3 | Li5.4PS4.4Cl0.8Br0.8 | 18 | 100 |
| Comparative | Li5.8PS4.8Cl1.2 | 42 | 190 |
| Example 1 | | | |
| Comparative | Li5.6PS4.6Cl1.4 | 33 | 156 |
| Example 2 | | | |
| Comparative | PEO-LiTFSI (5 wt %) | 0.5 | 183 |
| Example 3 | | | |

FIG. 2 shows the relationship between the Young's modulus of the solid electrolyte contained in the cathode active material layer of the evaluation battery and the resistance increase rate of the evaluation battery. From the results shown in Table 2 and FIG. 2, the following can be seen. First, comparing Examples 1 to 3 with Comparative Examples 1 and 2, it can be seen that when the Young's modulus of the inorganic-solid electrolyte contained in the cathode active material layer is equal to or less than 30 GPa, the resistivity increasing rate is significantly lower than when the Young's modulus exceeds 30 GPa. It is considered that the cathode active material having O2 type structure has a large volume change during charging and discharging, and the resistivity is increased by repeatedly shrinking and expanding the cathode active material, for example, by decreasing contacts between the inorganic-solid electrolyte and the cathode active material. Here, when the Young's modulus of the inorganic solid electrolyte is large, it is considered that the solid electrolyte is difficult to follow the volume change of the cathode active material, and the voids increase in the cathode active material layer, which is considered to lead to an increase in resistance. On the other hand, when the Young's modulus of the inorganic solid electrolyte is small, it is considered that the voids in the cathode active material layer are reduced by the inorganic solid electrolyte following the volume change of the cathode active material. The results of Examples 1 to 3 show that when the Young's modulus of the inorganic solid electrolyte contained in the cathode active material layer is equal to or less than 30 GPa value, even when the volume of the cathode active material changes, the inorganic solid electrolyte easily deforms and the increased voids in the cathode active material layer can be suppressed. In Comparative Example 3, an organic polymer electrolyte is used as the solid electrolyte contained in the cathode active material layer. In Comparative Example 3, although the Young's modulus of the solid electrolyte contained in the cathode active material layer was small, the resistance significantly increased. It is considered that the organic polymer electrolyte breaks along with the volume change of the active material, and the ion conduction path is blocked, and as a result, the resistance increases.

### 8. Supplement

In the above examples, examples of the cathode active material having a O2 type have been described. However, the chemical composition of the cathode active material having O2 type structure is not limited thereto. In addition, in the above-described embodiment, examples of the inorganic-solid electrolyte included in the cathode active material layers include those containing Li, P, S, and a halogen element. However, the chemical composition of the inorganic solid electrolyte contained in the cathode active material layer is not limited thereto. It is considered that the same effect can be achieved by using an inorganic-solid electrolyte having a Young's modulus of 30 GPa or less. Further, in the above example, an all-solid-state battery was exemplified as the battery for evaluation. However, other configurations are not limited as long as the cathode active material having a O2 type and the inorganic-solid electrolyte having a small Young's modulus are used in combination in the cathode active material layers. It is considered that the same effect can be obtained in a secondary battery including a part of a liquid as long as a cathode active material having a O2 type structure and an inorganic-solid electrolyte having a small Young's modulus are used in combination in the cathode active material layer.

### 9. Summary

From the above results, it can be said that the secondary battery having the following configuration can reduce an increase in resistance when charging and discharging are repeated.
(1) The secondary battery includes a cathode active material layer, a solid electrolyte layer, and an anode active material layer.
(2) The cathode active material layer includes a cathode active material having a O2 type structure.
(3) The cathode active material layer includes an inorganic-solid electrolyte having a Young's modulus of 30 GPa or less.

What is claimed is:

1. A secondary battery comprising a cathode active material layer, a solid electrolyte layer, and an anode active material layer, wherein:
the cathode active material layer includes a cathode active material having an O2 type structure; and
the cathode active material layer includes an inorganic solid electrolyte having a Young's modulus of 30 GPa or less.

2. The secondary battery according to claim 1, wherein the cathode active material at least includes, as constituent elements, at least one kind of transition metal element among Mn, Ni, and Co, Li, and O.

3. The secondary battery according to claim 2, wherein the cathode active material has a chemical composition represented by LiₐNa_{b}Mnₓ₋ₚNi_{y-q}Co_{z-r}M_{p+q+r}O₂, where 0<a≤1.00, 0≤b≤0.20, x+y+z=1, and 0≤p+q+r≤0.15 hold, and an element M is at least one kind selected from among B, Mg, Al, K, Ca, Ti, V, Cr, Fe, Cu, Zn, Ga, Ge, Sr, Y, Zr, Nb, Mo, and W.

4. The secondary battery according to claim 1, wherein the inorganic solid electrolyte at least includes Li, P, S, and a halogen element as constituent elements.

5. The secondary battery according to claim 1, wherein the Young's modulus of the inorganic solid electrolyte is 10 GPa or more and 30 GPa or less.
